(19) United States
(12) Patent Application Publication
(10) Pub. No.: US 2011/0139016 A1
(43) Pub. Date: Jun. 16, 2011

(54) Slit-cutting device for hot dogs, sausages and the like

(76) Inventor: John J. Romano, Conshohocken, PA (US)

(21) Appl. No.: 12/653,609

(22) Filed: Dec. 16, 2009

(51) Int. Cl. A47J 43/28

(52) U.S. Cl. 99/450.8

(57) ABSTRACT

A device that aids in the filling of hot dogs, sausage and the like with fillers such as cheese, mustard and condiments is disclosed. One embodiment discloses a blade having a spiral shape having a cutting edge lying substantially in a plane. The blade is attached to a hollow cylindrical member and the blade is positioned such that it remains interior to and centered within the hollow cylindrical member. The cutting edge cuts a curved incision when a hot dog is forced through the hollow cylindrical member and over the blade. The curved incision expands when filling with filler but springs back into position when released. Other alternative embodiments are presented.

### TECHNICAL FIELD

The present invention relates generally to cutting devices. More particularly the invention relates to devices that cut slits in tubular-shaped food.

### BACKGROUND OF THE DISCLOSURE

Insertion of a filler in tubular-shaped food such as hot dogs and sausages is a common practice. A slit is cut along the length of the hot dog and then the filler is spread inside the slit. Cheese, ketchup, mustard and condiments are common fillers used. However, the slit provides only a minimal surface area for the filler; it allows leakage; and it runs the risk of either being cut to an insufficient depth or of being cut too deep.

Another common practice is to insert a thin needle-like shaft through the length of the hot dog, and inject the filler by using a housing containing the filler attached to the needle-like shaft, and force the filler from the housing through the shaft via a plunger into the hot dog. Still another approach drills a core along the hot dog's center and then forces a filler through the core. However, these devices do not work well with fillers such as cheese and condiments. Therefore, there is a need for a device that allows a hot dog and the like to be filled such that a maximum amount of filler may be inserted and such that filler leakage is minimized.

### SUMMARY OF THE DISCLOSURE

The slit-cutting device of the present invention solves the problem of slitting a hot dog or other tubular shaped food in a manner that allows a filler, such as cheese, mustard, ketchup or condiments to be inserted in a slit. Once inserted, the tubular shaped food item has a minimum of leakage and has maximum filler capacity. In one embodiment, the device incorporates a blade having a cutting edge lying substantially in a plane such that the blade is spirally shaped and such that the blade is attached to and enclosed by a hollow cylindrical member. When the hollow cylindrical member is placed at one end of a tubular shaped food item and pushed in a direction along the longitudinal axis of the tubular shaped food item through the hollow cylindrical member, a curved incision is cut in the tubular shaped food item. The curved incision may then be spread apart and the filler inserted using a curved incision spreader or by using one's fingers. Once the filling is completed, the tubular shaped food item's slit springs back thus retaining the filler.

An alternate embodiment to the basic slit-cutting device has the spiral shaped blade attached to a hollow cylindrical member segment and includes mechanisms that allow the hollow cylindrical member's diameter and blade position within the hollow cylindrical member to be adjusted. In another alternative embodiment, a tube is attached to the hollow cylindrical member, and a plunger that pushes the tubular shaped food item through the tube over the blade is provided.

### BRIEF DESCRIPTION OF THE DRAWINGS

FIG. 1A is a perspective view of a spiral blade of the present invention.

FIG. 1B is a sectional view of FIG. 1A taken perpendicular to the sides of the blade.

FIG. 2A is a perspective view of a first embodiment of the present invention.

FIG. 2B is a sectional view of the first embodiment taken parallel to the plane of the cutting edge.

FIG. 3A is a perspective view of a second embodiment of the present invention.

FIG. 3B is a sectional view of the second embodiment taken parallel to the plane of the cutting edge.

FIG. 4A is a perspective view of a third embodiment of the present invention.

FIG. 4B is a diameter-adjusting mechanism detail of FIG. 4A.

FIG. 4C is a sectional view of the diameter-adjusting mechanism of FIG. 4B.

FIG. 4D is a blade-positioning mechanism detail of FIG. 4A.

FIG. 4E is a sectional view of the blade-positioning mechanism of FIG. 4D.

FIG. 5A is a cutout view illustrating the cutting of a curved incision in a tubular shaped food item using the first embodiment.

FIG. 5B is a tubular shaped food item having a curved incision created by using the first embodiment.

FIG. 5C is the use of a tong-like spreader to spread apart the curved incision created by the first embodiment.

FIG. 5D is a tubular shaped food item having a filler inserted.

FIG. 6A is a perspective view of a kit containing three different sizes of the first embodiment of the device of the present invention.

FIG. 6B is a perspective view of a composite tool utilizing three different sizes of the first embodiment of the device of the present invention.

FIG. 7 is a perspective view of a fourth embodiment of the present invention.

FIG. 8A is a perspective view of a fifth embodiment of the present invention.

FIG. 8B is a sectional view of FIG. 8A.

FIG. 9A is a perspective view of a sixth embodiment of the present invention having the case opened.

FIG. 9B is a perspective view of the sixth embodiment of FIG. 9A having the case closed.

FIG. 9C is a sectional view of FIG. 9B.

FIG. 9D is a perspective of the blade assembly of the sixth embodiment of the present invention.

### DETAILED DESCRIPTION

As used in this specification, the terms left, right, top and bottom, upwards and downwards refer to the figure that the reference numeral refers to.

The term hot dog, when used in the detailed description, applies equally to other tubular-shaped food items such as frankfurters, knockwurst and sausages.

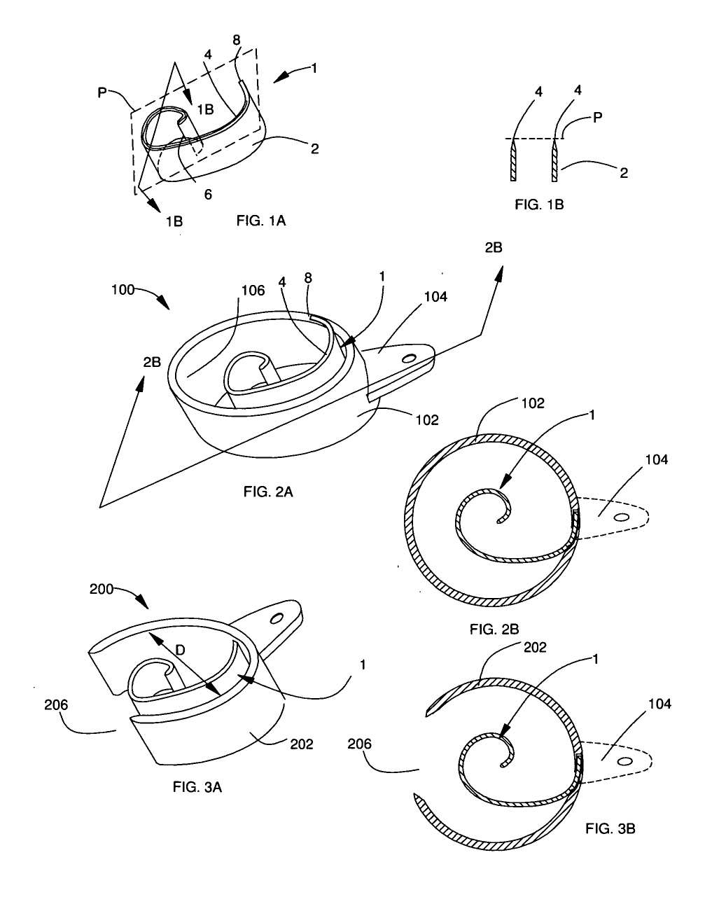

FIG. 1A illustrates a blade 1 comprising a flat shaft 2 having a cutting edge 4. Cutting edge 4 is positioned on shaft 2 of the blade such that cutting edge 4 lies substantially in a plane P and such that a substantial portion of shaft 2 containing cutting edge 4 is substantially spiral-shaped. Blade 1 has a first end 6 terminating at the inside portion of the spiral and an opposing second end 8.

FIG. 1B is a sectional view of blade 1 taken perpendicular to plane P determined by cutting edge 4. Shaft 2 is perpendicular to plane P along the length of blade 1.

FIGS. 2A and 2B illustrate a first embodiment 100 of the present invention in which blade 1 is attached to a hollow cylindrical member 102 at second end 8 of blade 1. The spiral portion of blade 1 lies within the interior portion 106 of hollow cylindrical member 102. Hollow cylindrical member 102 has an optional grip 104. FIG. 2B is a sectional view of FIG. 2A taken in a plane parallel to plane P of cutting edge 4. Hollow cylindrical member 102 of first embodiment 100 is preferably made of a rigid material.

FIG. 3A illustrates a second embodiment 200 of the present invention. Second embodiment 200 has the shape of a hollow cylindrical member segment 202 having an opening 206. A sectional view of hollow cylindrical member segment 202 is illustrated in FIG. 3B. Hollow cylindrical member segment 202 is preferably made of a semi-rigid material so inside diameter D of hollow cylindrical member segment 202 may be expanded to accommodate different size hot dogs.

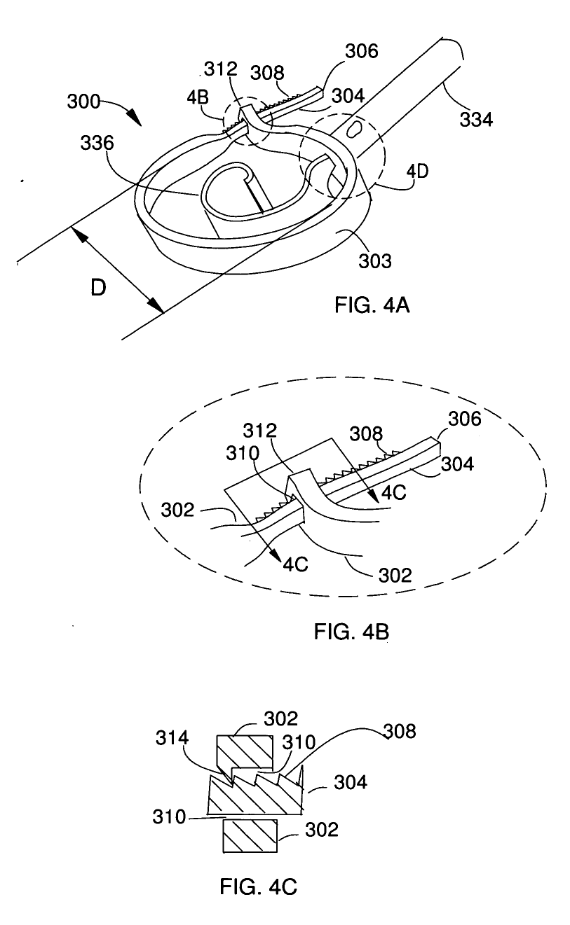

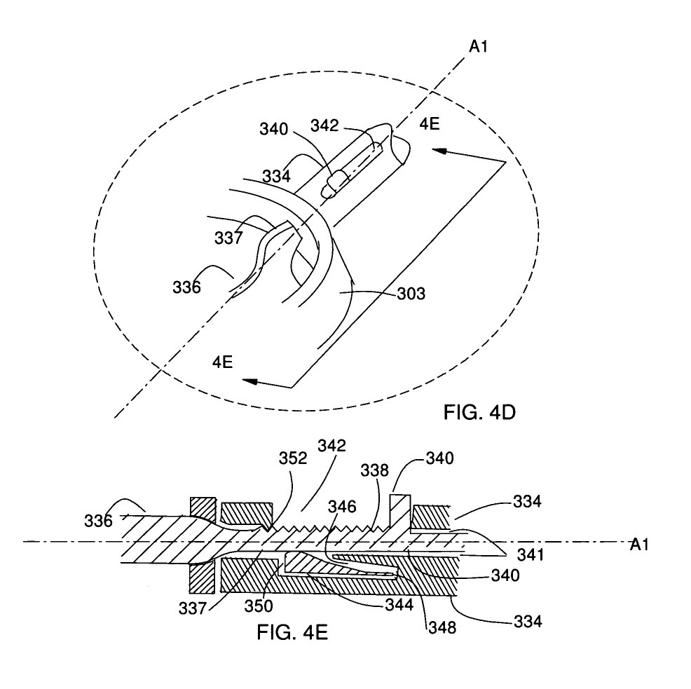

FIGS. 4A through 4E illustrate a third embodiment 300 of the present invention. Third embodiment 300 modifies the design of the hollow cylindrical member 102 of the first embodiment 100 so inside diameter D of a hollow cylindrical member 303 of third embodiment 300 can be adjusted. Third embodiment 300 also has a blade 336 and has a cylindrical handle 334 so the location of blade 336 within the hollow cylindrical member 303 can be adjusted once inside diameter D is set.

FIG. 4B illustrates an expanded scale perspective view of a detail of a diameter-adjusting mechanism of third embodiment 300. FIG. 4C is a sectional view of FIG. 4B. Hollow cylindrical member 303 is formed from a semi-rigid, springy, elongate flat band 302 that is bent in the shape of a hollow cylindrical member 303. Elongate flat band 302 has a narrow leg 304 located on a first end 306 having a set of teeth 308, and also has a rectangular opening 310 near a second end 312 that accepts narrow leg 304 such that narrow leg 304 fits through rectangular opening 310. Rectangular opening 310 has a tooth 314 as illustrated in FIG. 4C. The diameter-adjusting mechanism of elongate flat band 302 is sized and configured such that when narrow leg 304 is inserted in rectangular opening 310, teeth 308 on narrow leg 304 engage tooth 314 in rectangular opening 310 when pressed against teeth 308. Inside diameter D of hollow cylindrical member 303 may be made larger or smaller by moving narrow leg 304 back and forth within rectangular opening 310. Elongate band 302, when it is shaped like a hollow cylindrical member with narrow leg 304 inserted in rectangular opening 310 of second end 312, provides outwards tension. This causes teeth 308 of narrow leg 304 to be pressed against tooth 314, thereby locking elongate flat band 302 to form a hollow cylindrical member 303 of fixed inside diameter D. Once a desired inside diameter D is achieved, narrow leg 304 is released, thereby locking hollow cylindrical member 303 at desired inside diameter D.

FIG. 4D is an expanded scale perspective view of the blade-positioning mechanism of FIG. 4A. FIG. 4E is a sectional view of the blade-positioning mechanism of FIG. 4D. Referring to FIGS. 2A, 4A, 4D, and 4E, blade 1 of first embodiment 100 is replaced by blade 336 that has the same spiral shape as blade 1, but has a rectangular leg 337 at one end. Rectangular leg 337 has a row of teeth 338 and a tab 340 to the right of teeth 338. Cylindrical handle 334 has a cavity 341 that accepts rectangular leg 337 and also has a first slot 342 that allows tab 340 to move back and forth in the direction of the longitudinal axis A1 of cylindrical handle 334. A spring component 344 fits in a second slot 346 located in cylindrical handle 334 below cavity 341. Spring component 344 is attached to second slot 346 at a first end 348 of spring component 344, but otherwise may spring up and down. Spring component 344 has a tension that forces a second end 350 of spring component 344 upwards toward the bottom of rectangular leg 337, thereby forcing rectangular leg 337 upward such that teeth 338 engage a tooth 352 located in cylindrical handle 334. Teeth 338, second slot 346, spring component 344, and tooth 352 are sized and configured such that blade 336 may move back and forth along the longitudinal axis A1 of cylindrical handle 334 when tab 340 is pressed down so tooth 352 does not engage teeth 338. When tab 340 is released, teeth 338 and tooth 352 engage thereby locking blade 336. This procedure allows the spiral portion of blade 336 to be positioned centrally located relative to hollow cylindrical member 303.

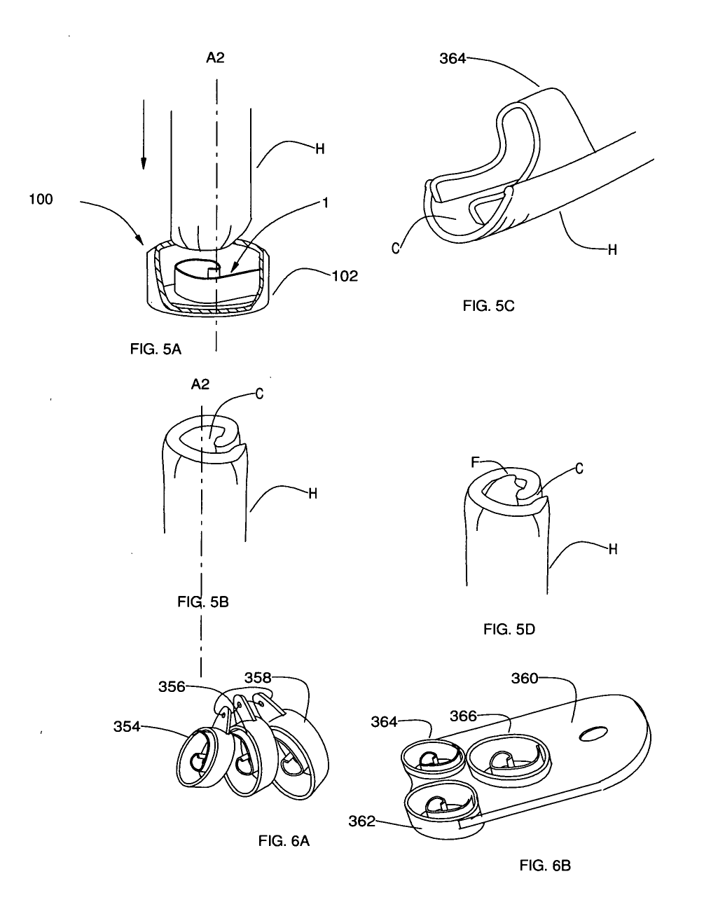

FIGS. 5A through 5D illustrate the use of the first embodiment 100 for filling a hot dog. Hot dog H is placed above blade 1 and pushed downward through hollow cylindrical member 102. As the hot dog H traverses through hollow cylindrical member 102, spiral blade 1 cuts a curved incision C along the length of hot dog H. FIG. 5B illustrates hot dog H having a curved incision C that has been cut along the longitudinal axis A2 of hot dog H. To add filler to hot dog H, hot dog H is placed on a horizontal surface (not illustrated in FIG. 5C) or held in a user's hand, and curved incision C is spread apart. The user may use a knife, a spoon, the user's fingers or an optional tong-like curved incision spreader 364 as illustrated in FIG. 5C. When curved incision C is spread apart, filler F may be added. Curved incision C tends to return to its closed position when released. FIG. 5D illustrates hot dog H having filler F added and curved incision C closed.

The first, second and third embodiments of the present invention may be adapted to accommodate hot dogs of various sizes. The first embodiment 100 has hollow cylindrical member 102 matched to a hot dog size so hot dog H fits snugly inside hollow cylindrical member 102. To adapt the first embodiment 100 to be used with various size hot dogs, a kit having different hollow cylindrical member sizes may be provided. FIG. 6A illustrates the first embodiment 100 of the present invention implemented in three sizes 354, 356 and 358. FIG. 6B illustrates a tool 360 having three sizes of the device 362, 364 and 366 of the first embodiment 100.

FIG. 7 illustrates a fourth embodiment 400. It has a first hollow tube 402 attached to the top of the hollow cylindrical member 102 of first embodiment 100, centered on hollow cylindrical member 102. First hollow tube 402 is attached to hollow cylindrical member 102 such that an interior portion 106 of the hollow cylindrical member 102 so an interior cylinder 406 of first hollow tube 402 extends interior portion 106 of hollow cylindrical member 102 to form a single cylindrical surface. A plunger 404, sized to fit inside first hollow tube 402, is included.

Refer now to FIGS. 5A, 5B and 7. To operate fourth embodiment 400, hot dog H is inserted in first hollow tube 402, and the user inserts plunger 404 in first hollow tube 402 and then pushes plunger 404 against hot dog H such that hot dog H is pushed through tube 402 against blade 1. When hot dog H emerges from tube 402, curved incision C has been cut into hot dog H. Hot dog H is not shown in FIG. 7.

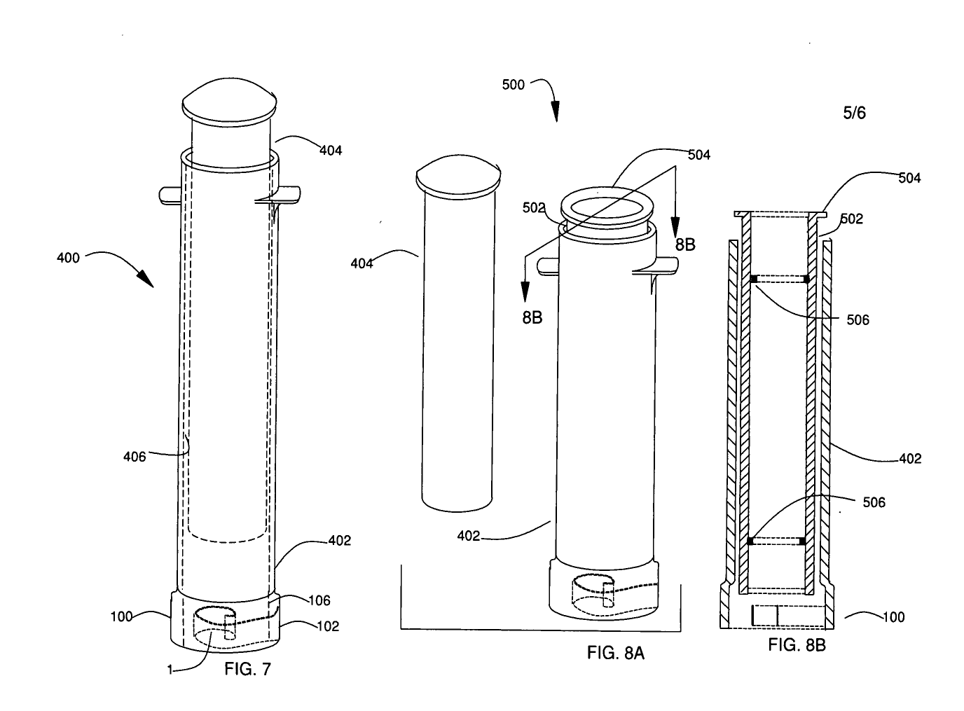

FIGS. 8A and 8B illustrate a fifth embodiment 500 of the present invention, which includes all the components of the fourth embodiment 400, and has an additional second hollow tube 502 that fits in first hollow tube 402. Plunger 404 is resized such that it fits inside the second hollow tube 502. Fifth embodiment 500 works over a wider range of hot dog sizes than the fourth embodiment 400, since it may be used without second hollow tube 502 for one size of hot dog, and when second hollow tube 502 is in place, it may be used for hot dogs of a smaller diameter. Second hollow tube 502 has a lip 504 that prevents second hollow tube 502 from falling thorough first hollow tube 402 and allows second hollow tube 502 to be gripped easily. Second hollow tube 502 has two optional rings 506 placed inside of second hollow tube 502 to allow a smaller hot dog to slide smoothly. Use of plunger 404, first hollow tube 402 and second hollow tube 502 makes cutting the curved incision C easier, since fifth embodiment 500 provides support for the hot dog as it is being pushed against blade 1. The hot dog is not shown in FIGS. 8A and 8B.

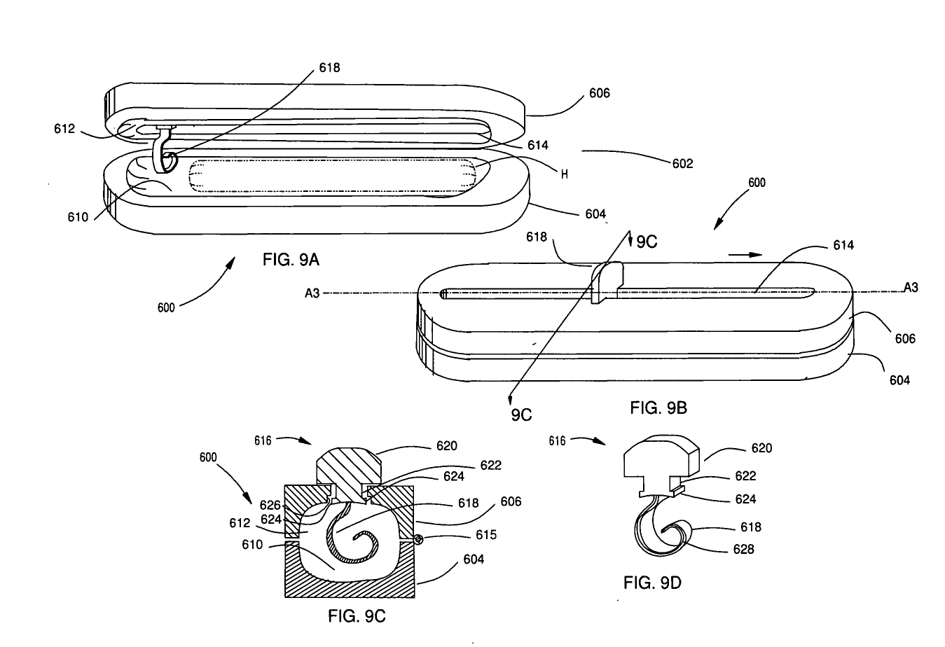

FIGS. 9A through 9D illustrate a sixth embodiment 600 of the present invention. Sixth embodiment 600 has a case 602 having a bottom case component 604 and a top case component 606 that are joined together by a hinge 615 positioned at the back of case 602 such that case 602 opens and closes like a clamshell. Bottom case component 604 has a bottom cavity 610 and the top case component 606 has a top cavity 612. Bottom cavity 610 and top cavity 612 accommodate a hot dog H with room to spare to accommodate blade 618. When hot dog H is placed in bottom cavity 610 and positioned toward the right end of bottom cavity 610, and case 602 is closed, hot dog H is constrained by bottom cavity 610 and top cavity 612. When case 606 is opened hot dog H is removable. Top case component 606 has a slot 614 that runs along a longitudinal axis A3 of case 602 and is centered on cavity 612. The upper case slot 614 accommodates a spiral blade assembly 616 comprised of a spiral blade 618, a short rectangular shaft 622, a tab 624 and a handle 620. Tab 624 of spiral blade assembly 616 is matched to a notch 626 located on slot 614 such that spiral blade assembly 616 moves to the left and right within slot 614, but is restricted from moving in an up and down motion or in a rotational motion with respect to slot 614.

Spiral blade 618 has a cutting edge 628 that is positioned in a plane that is perpendicular to longitudinal axis A3. Sixth embodiment 600 of the present invention is sized and configured such that blade assembly 616 moves to the right and left while being constrained by slot 614. To use sixth embodiment 600, hot dog H is inserted in bottom cavity 610 positioned toward the right end of bottom cavity 610, and case 602 is closed with blade assembly 616 initially positioned to the extreme left of bottom cavity 610. When assembly 616 is moved from left to right, a curved incision is cut in hot dog H. Once the curved incision is cut in hot dog H, case 602 is opened and hot dog H is removed.

The hollow cylindrical members 102 and 303 of the present invention disclosed herein have annular cross sections, that is cross sections consisting of concentric circles. However other cross sections are included in the present invention, such as but not limited to those with elliptical and rectangular concentric shapes, as well as cross sections that vary in shape along different cross sections.

The spiral blade of the present invention disclosed herein is spiral-shaped. However other shapes that depart from a strict spiral that cut curved incisions in a tubular shaped food item, such as but not limited to hook-shaped, U-shaped and C-shaped are included in the present invention.

The embodiments of the present invention are to be considered as only illustrative of the present invention and not a limitation of the scope of the present invention. Various permutations, combinations, variations and extensions of these embodiments are considered to fall within the scope of the present invention. Therefore the scope of this slit-cutting device should be determined with respect to the claims and not just by the embodiments presented.

What is claimed is:

1. A device for cutting a curved incision in a tubular shaped food item comprising:
a blade having a shaft, the shaft having a cutting edge wherein the cutting edge lies substantially in a plane and wherein the shaft has a spiral shape on a substantial portion of the blade's shaft.

2. The device of claim 1 further comprising:
a hollow cylindrical member segment, wherein the blade is attached to the hollow cylindrical member segment at a first end of the shaft.

3. The device of claim 2 wherein the hollow cylindrical member segment is constructed out of a flexible material that allows the hollow cylindrical member segment to be adjusted such that it accommodates tubular shaped food items of different diameters.

4. A device for cutting a curved incision in a tubular shaped food item comprising:
a blade having a shaft, the shaft having a cutting edge wherein the cutting edge lies substantially in a plane and wherein the shaft has a substantially spiral shape on a substantial portion of the shaft;
a hollow cylindrical member having an interior portion, the interior portion having an inside diameter, wherein the hollow cylindrical member is sized such that the blade is attached to the hollow cylindrical member at a first end of the shaft and wherein the cutting edge has a position substantially within the interior portion of the hollow cylindrical member.

5. The device of claim 4 further comprising:
a hollow tube having an interior cylinder, the hollow tube being attached to the hollow cylindrical member such that the interior cylinder extends the interior portion of the hollow cylindrical member; and
a plunger that fits in the hollow tube.

6. The device of claim 4 further comprising a mechanism for adjusting the inside diameter of the hollow cylindrical member.

7. The device of claim 4 further comprising a mechanism for adjusting the position of the blade within the hollow cylindrical member.

8. The device of claim 4 further comprising a tong-like spreader that may be used for spreading a curved incision in a tubular shaped food item.

9. A device for cutting a curved incision in a tubular shaped food item comprising:
a blade having a shaft, the shaft having a cutting edge wherein the cutting edge lies substantially in a plane and wherein the shaft has a substantially spiral shape on a substantial portion of the shaft; and
a case, wherein the case is comprised of a first elongate member and a second elongate member, the second elongate member having a longitudinal axis, wherein the first elongate member and the second elongate member have a mechanism for opening and closing the case, and wherein the first elongate member has a first cavity and the second elongate member has a second cavity such that when the case is closed a tubular shaped food item fits in and is constrained by the first cavity and the second cavity, the second elongate member having a slot along the longitudinal axis, and wherein the blade further comprises a blade assembly, wherein the blade assembly is constrained in the slot to move along the longitudinal axis with the plane of the cutting edge being perpendicular to the longitudinal axis, the cutting edge being contained within the first cavity and the second cavity.
